(19) United States
(12) Patent Application Publication
(10) Pub. No.: US 2011/0018836 A1
(43) Pub. Date: Jan. 27, 2011

(54) CAPACITIVE TOUCH CONTROL MODULE AND METHOD FOR MAKING THE SAME

(75) Inventor: TZU-CHENG YU, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/731,236

(22) Filed: Mar. 25, 2010

(30) Foreign Application Priority Data
Jul. 21, 2009 (CN) 200920306578.4

(51) Int. Cl. G06F 3/044; H01R 43/00

(52) U.S. Cl. 345/174; 29/825

(57) ABSTRACT

A capacitive touch control module includes a touch screen, an indium tin oxide conducting layer and a shell. The touch screen has an outer surface and an opposite inner surface. The indium tin oxide conducting layer is disposed on the inner surface of the touch screen and thus forms a touch sensing circuit. The shell is substantially concave frame shape and a shell surrounds the periphery of the touch screen. An outer periphery flange of the shell is higher than an inner circumference flange of the shell. The plane of the touch screen is lower than the outer periphery flange of the shell.

### BACKGROUND

1. Technical Field

The present disclosure relates to a control modules and, particularly, to a capacitive touch control module and method for making the same.

2. Description of Related Art

Touch screen technologies are widely applied to electronic devices e.g., notebooks, mobile phones, personal digital assistants, etc. A typical capacitive touch control module includes a touch screen, an indium tin oxide conducting layer and a shell. The touch screen is a transparent board (e.g. glass board) attached to the shell, thereby forming a touch panel. The indium tin oxide conducting layer is coated on an inner surface of the touch screen, thereby forming a touch sensing circuit on the inner surface of the touch screen. The outer periphery flange of the shell is positioned coplanar with the outer surface of the touch screen, however, easily subjects to abrasion under frequent contacting of touching pen.

Therefore, there is room for improvement within the art.

### BRIEF DESCRIPTION OF THE DRAWINGS

Many aspects of the present disclosure can be better understood with reference to the following drawings. These drawings are not necessarily drawn to scale, the emphasis instead being placed upon clearly illustrating the principles of the present capacitive touch control module and method for making the same. Moreover, in the drawings like reference numerals designate corresponding sections throughout the several views.

FIG. 1 is an isometric view of an electronic device incorporating a capacitive touch control module, in accordance with an exemplary embodiment.

FIG. 2 is a sectional view of the capacitive touch control module, in accordance with an exemplary embodiment.

FIG. 3 is an assembled isometric view of a preassembled touch control module, in accordance with an exemplary embodiment.

FIG. 4 is a sectional schematic view illustrating/showing the method for making the capacitive touch control module, in accordance with an exemplary embodiment, wherein, the preassembled touch control module is going to be put into a female mold as an inserted piece.

FIG. 5 is a second sectional schematic view illustrating/showing the method for making the capacitive touch control module, in accordance with an exemplary embodiment, wherein, the preassembled touch control module is assembled within the female mold and clamped/held between a male mold and the female mold.

FIG. 6 is another sectional schematic view illustrating/showing the method for making the capacitive touch control module, in accordance with an exemplary embodiment, wherein, the capacitive touch control module is formed within the mold.

### DETAILED DESCRIPTION

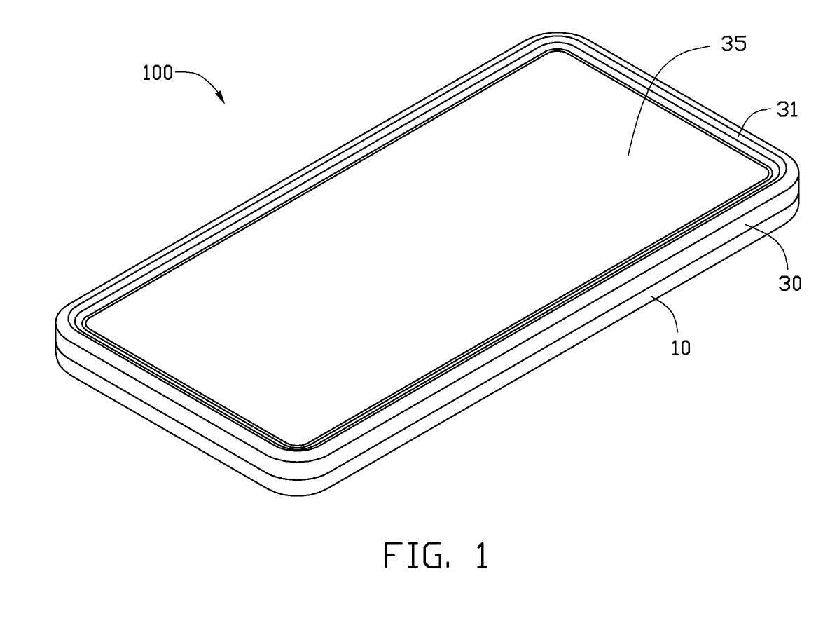

FIG. 1 shows an exemplary electronic device 100 incorporating a capacitive touch control module 30. The electronic device 100 may be a mobile phone, an MP3 player, a digital camera or a personal digital assistant (PDA), etc. The electronic device 100 includes a main body 10 and a capacitive touch control module 30 detachably mounted on the main body 10. The main body 10 incorporates a plurality of electronic components (not shown) such as circuit board, functional modules, etc. assembled therein.

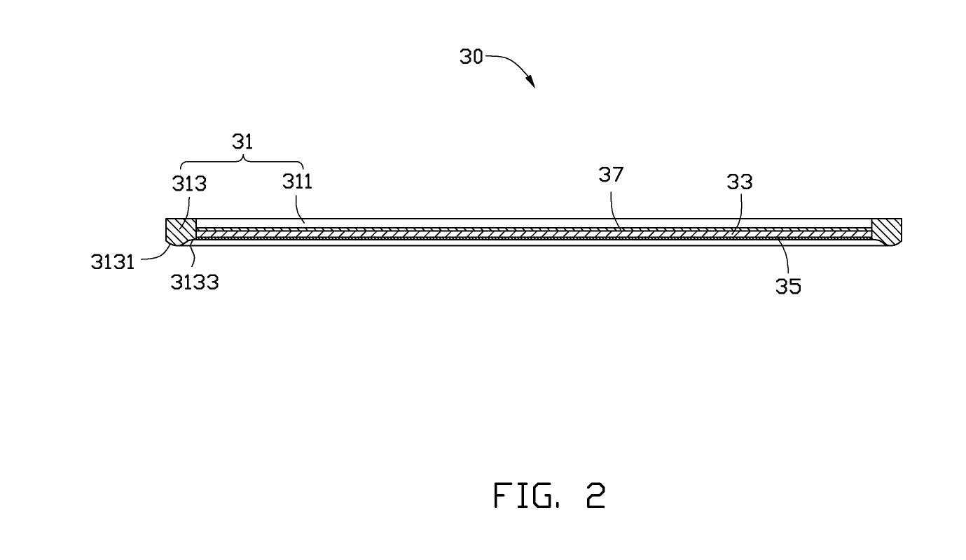

Referring further to FIG. 2, the capacitive touch control module 30 includes a shell 31, a touch screen 33, a protective layer 35 and an indium tin oxide conducting layer 37. The shell 31 is a concaved frame, and includes a rectangular through window 311 and a peripheral frame 313 enclosing the window 311. The peripheral frame 313 has an outer periphery flange 3131 and an opposite inner circumference flange 3133. The outer periphery flange 3131 is higher than the inner circumference flange 3133 relative to the bottom of the peripheral frame 313. In the present exemplary embodiment, the shell 31 can be injection molded.

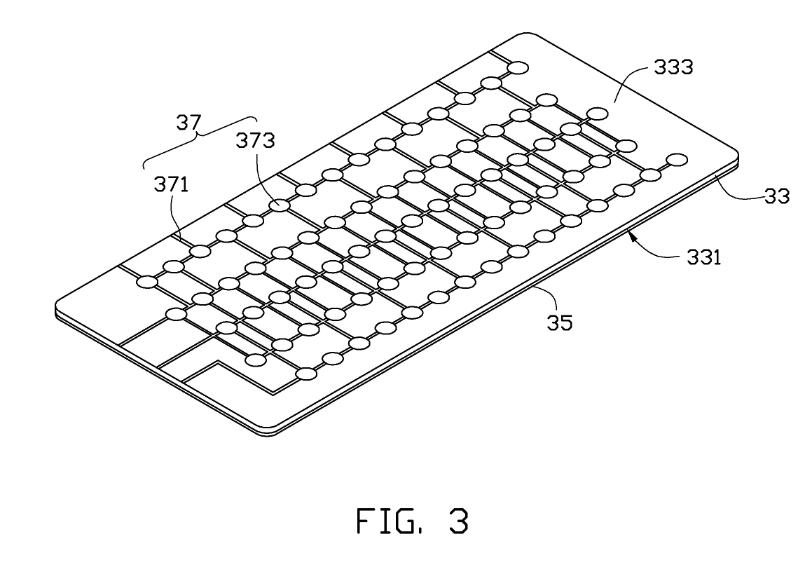

Referring also to FIG. 3, the touch screen 33 is a rectangular transparent glass board. The touch screen 33 is assembled within the window 311 of the shell 31 and enclosed by the peripheral frame 313. The touch screen 33, the peripheral frame 313 and the window 311 cooperatively form a touch control panel. The touch screen 33 has an outer surface 331 and an opposite inner surface 333. The touch screen 33 and the shell 31 can be integrally formed by in-mold labeling.

The protective layer 35 is an optical transparent film and can be adhered to the outer surface 331 of the touch screen 33 for protecting the outer surface 331 from wearing or abrasion. The indium tin oxide conducting layer 37 is coated on the inner surface 333 of the touch screen 33 by vacuum sputtering to form a netted capacitive touch sensing circuit 371 on the inner surface 333. Accordingly, a plurality of capacitive grids 373 are formed at the joints of the netted capacitive touch sensing circuit 371. The indium tin oxide conducting layer 37 can electrically connect the circuit board of the main body 10 to generate respective electric signal corresponding to the touching by a touch pen on the touch screen 33. The generated electric signal can enable a specifically identified action for the electronic device 100.

Referring to FIGS. 3-6, an exemplary method for making the capacitive touch control module 30 may include the following steps.

The touch screen 33 is provided, and made of high heat-resistant material such as a high heat-resistant glass board.

The indium tin oxide conducting layer 37 is formed on the inner surface 333 of the touch screen 33 by vacuum sputtering or printing.

The indium tin oxide conducting layer 37 is exposed to light, developed, and etched, to form the netted capacitive touch sensing circuit 371.

The optical transparent protective layer 35 is provided to adhere to the outer surface 331 of the touch screen 33. At this time, a preassembled touch control module is formed (shown in FIG. 3).

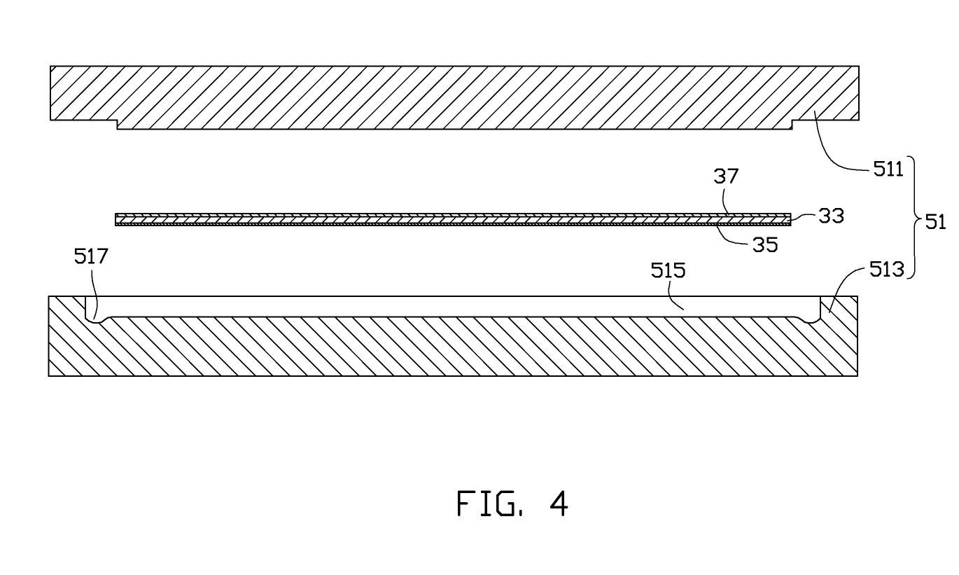

Referring to FIG. 4, an injection mold 51 is provided including a male mold 511 and a female mold 513. A mold cavity 515 is defined in the female mold 513 to accommodate the preassembled touch control module therein. A concave annular groove 517 is recessed from the peripheral of the mold cavity 515 and is configured to form the shell 31 integrally enclosing the preassembled touch control module by in-mold labeling.

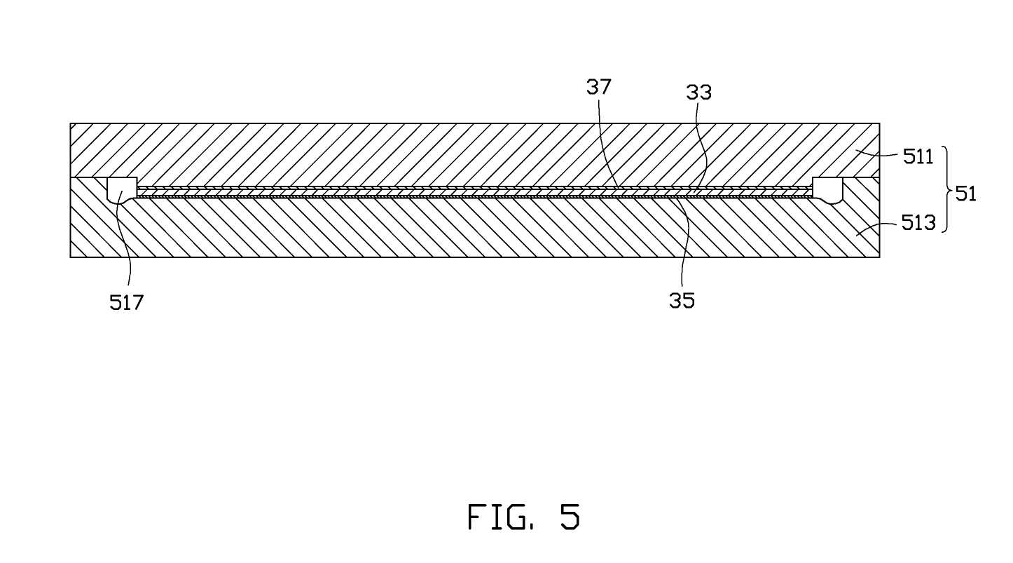

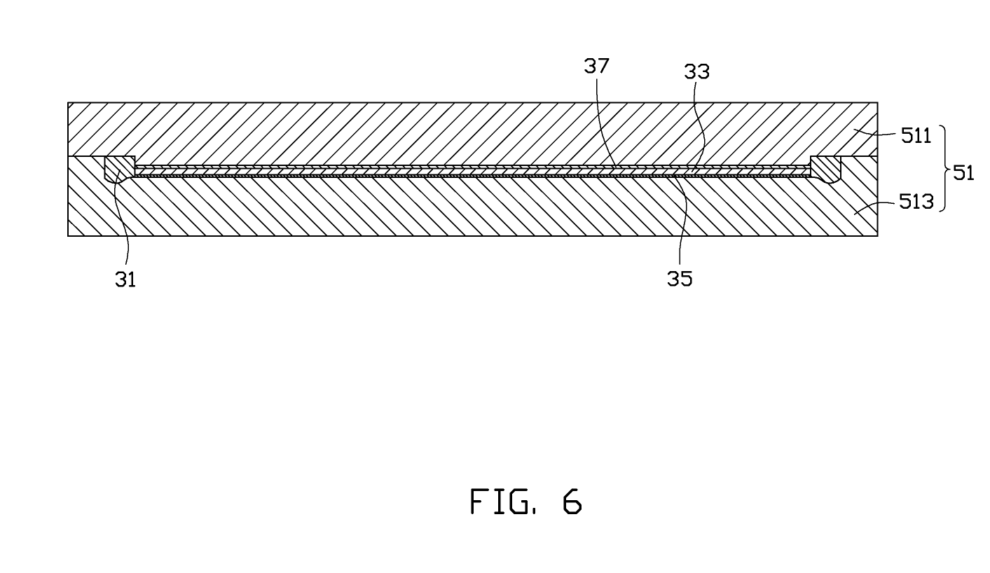

Referring to FIGS. 5-6, the preassembled touch control module is placed into the mold cavity 515 of the female mold 513. Molten materials are injected into the mold 51 to form the shell 31. The shell 31 encloses the touch screen 33 with the inner circumference 3133 parallel to the surface of the touch screen 33. The outer periphery flange 3131 of the shell 31 is higher than the inner circumference flange 3133, accordingly preventing the touch screen 33 from wearing or abrasion of frequent contacting by the touching pen. The molded capacitive touch control module 30 can be taken out of the mold cavity 515 after the mold 51 is opened.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A capacitive touch control module, comprising:
a touch screen having an outer surface and an opposite inner surface;
an indium tin oxide conducting layer disposed on the inner surface of the touch screen, and there forming a touch sensing circuit on the inner surface of the touch screen; and
a shell surrounding the periphery of the touch screen;
wherein, the shell includes an outer periphery flange and an inner circumference flange, the outer periphery flange of the shell is higher than the inner circumference flange; the plane of the touch screen is lower than the outer periphery flange of the shell.

2. The capacitive touch control module as claimed in claim 1, wherein the shell is substantially concave frame shape, the shell is integrally formed with the touch screen by injection molding technology with in one mold.

3. The capacitive touch control module as claimed in claim 1, wherein the capacitive touch control module further includes a protective layer adhered to the outer surface of the touch screen.

4. The capacitive touch control module as claimed in claim 3, wherein the protective layer is an optical transparent film.

5. The capacitive touch control module as claimed in claim 3, wherein the shell includes a window defined therethrough and a peripheral frame enclosing/surrounding the window; the touch screen is assembled within the window of the shell and enclosed or surrounded by the peripheral frame.

6. The capacitive touch control module as claimed in claim 5, wherein the peripheral frame has an outer periphery flange and an opposite inner circumference flange, the outer periphery flange is higher than the corresponding inner circumference flange.

7. The capacitive touch control module as claimed in claim 6, wherein the peripheral frame is concaved from the outer periphery flange toward the inner circumference flange, thereby forming a concave curved surface.

8. The capacitive touch control module as claimed in claim 1, wherein the indium tin oxide conducting layer is disposed by vacuum sputtering technology to form a net shaped capacitive touch sensing circuit on the inner surface, and thus form several capacitive grids at respective conjunctions of the capacitive touch sensing circuit.

9. The capacitive touch control module as claimed in claim 8, wherein the touch screen is a transparent glass board made of high heat-resistant material.

10. A method for making the capacitive touch control module comprising:
providing a touch screen made of high heat-resistant transparent material;
forming an indium tin oxide conducting layer on an inner surface of the touch screen, thereby forming a netted shaped capacitive touch sensing circuit on the inner surface thereof;
providing an injection mold; the injection mold comprising a male mold and a female mold defining a mold cavity therein for accommodating the touch screen therein;
putting the touch screen in the mold cavity of the female mold, and injecting the fused material into the mold to form the shell surrounding the periphery of the touch screen.

11. The method for making the capacitive touch control module as claimed in claim 10, wherein further includes a step before putting the touch screen into the mold cavity, there includes the step by disposing an optical transparent protective layer on an outer surface of the touch screen for protecting the outer surface.

12. The method for making the capacitive touch control module as claimed in claim 10, wherein the indium tin oxide conducting layer is disposed on the inner surface of the touch screen by vacuum sputtering; and thus forms several capacitive grids at respective joints of the capacitive touch sensing circuit.

13. The method for making the capacitive touch control module as claimed in claim 10, wherein the mold cavity includes a concave annular groove recessed in from the peripheral thereof configured to form the shell surrounding the touch screen; the shell includes an inner circumference flange parallel to the plane of the touch screen and an outer periphery flange higher than the corresponding inner circumference flange.
